(19) United States
(12) Patent Application Publication
(10) Pub. No.: US 2025/0091158 A1
(43) Pub. Date: Mar. 20, 2025

(54) CONTINUOUS LASER PROCESSING SYSTEM AND PROCESSING METHOD

(71) Applicant: INDUSTRIAL TECHNOLOGY RESEARCH INSTITUTE, Chutung (TW)

(72) Inventors: Zih-Yi LI, Tainan City (TW); Ping-Han WU, Tainan City (TW); Yi-Chi LEE, Taichung City (TW); Shang-Yu HSU, Tainan City (TW); Ji-Bin HORNG, Tainan City (TW)

(73) Assignee: INDUSTRIAL TECHNOLOGY RESEARCH INSTITUTE, Chutung (TW)

(21) Appl. No.: 18/531,410

(22) Filed: Dec. 6, 2023

(30) Foreign Application Priority Data
Sep. 15, 2023 (TW) 112135253

(51) Int. Cl. B23K 26/082

(52) U.S. Cl. CPC B23K 26/082

(57) ABSTRACT

A continuous laser processing system for internal modification of transparent materials includes a pulse laser device, a scanning device, a processing platform and a control device. The pulse laser device is configured to output a laser beam. The scanning device includes a mirror group controller and a mirror group and controlled to guide the laser beam to the transparent material, wherein the mirror group is disposed at an output path of the laser beam. The processing platform is configured to carry the transparent material and controlled to move. The control device is electrically connected to the scanning device and the processing platform, and is configured to control the scanning device to form a processing trajectory at the transparent material at a scanning speed, and to control the processing platform to move at a translation speed, wherein the scanning speed is at least 20 times the translation speed.

### CROSS-REFERENCE TO RELATED APPLICATIONS

This non-provisional application claims priority under 35 U.S.C. § 119(a) on Patent Application No(s). 112135253 filed in Republic of China (ROC) on Sep. 15, 2023, the entire contents of which are hereby incorporated by reference.

### BACKGROUND

### 1. Technical Field

This disclosure relates to a continuous laser processing system and processing method.

### 2. Related Art

With the booming development of the electric vehicle market, the demand for power semiconductors such as silicon carbide (SiC) related to power supply and power control applications is increasing. For silicon carbide wafer dicing used in the semiconductor industry, there are several processing methods, such as grinding wheel dicing, laser full dicing, laser half dicing, laser stealth dicing, and water-guided laser dicing, wherein the processing method that combines laser stealth dicing and slitting is considered to have the advantages of high processing efficiency and processing effects that meet production requirements. Therefore, the industry is increasingly relying on the technology of using laser to cut semiconductor wafers.

Current laser cutting modules usually use a single light spot for linear modification processing. Its overall cutting efficiency is affected by the processing line width and is difficult to significantly improve.

### SUMMARY

According to one or more embodiment of this disclosure, a continuous laser processing system includes a pulse laser device, a scanning device, a processing platform and a control device. The pulse laser device is configured to output a laser beam. The scanning device includes a mirror group controller and a mirror group and controlled to guide the laser beam to the transparent material, wherein the mirror group is disposed at an output path of the laser beam. The processing platform is configured to carry the transparent material and controlled to move. The control device is electrically connected to the scanning device and the processing platform, and is configured to control the scanning device to form a processing trajectory at the transparent material at a scanning speed, and to control the processing platform to move at a translation speed, wherein the scanning speed is at least 20 times the translation speed.

According to one or more embodiment of this disclosure, a continuous laser processing method includes outputting a laser beam by a pulse laser device; guiding the laser beam to the transparent material located on a processing platform by a scanning device; controlling the scanning device to form a processing trajectory at the transparent material at a scanning speed by a control device; and controlling the processing platform to move at a translation speed by the control device, wherein the scanning speed is at least 20 times the translation speed.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram of a continuous laser processing system according to an embodiment of the present disclosure;

FIG. 2 is a flow chart of a continuous laser processing method according to an embodiment of the present disclosure;

FIG. 3 is a schematic diagram of a continuous laser processing system according to another embodiment of the present disclosure;

FIG. 4 is a flow chart of controlling the scanning device to form a processing trajectory on a transparent material at a scanning speed of a continuous laser processing method according to an embodiment of the of the present disclosure;

FIGS. 5a to 5d are schematic diagrams of forming a processing trajectory of the continuous laser processing method according to an embodiment of the present disclosure; and

FIG. 6 is a photograph of a cross-section surface of a processed material formed by a continuous laser processing method according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

The present disclosure proposes a continuous laser processing system and method, which are applicable for internal modification of transparent materials. The “continuous laser processing” refers to a technology that simultaneously controls the laser scanning device to perform scanning and controls the movement of a processing platform carrying the object to be processed. By controlling the two speeds mentioned above to be above a specific magnification, a dense periodic processing trajectory (laser modification area) may be formed on the object to be processed along the translation direction of the processing platform, so that when the periodic processing trajectory is dense enough, the laser modification area may be regarded as a continuous modification area, as details described below.

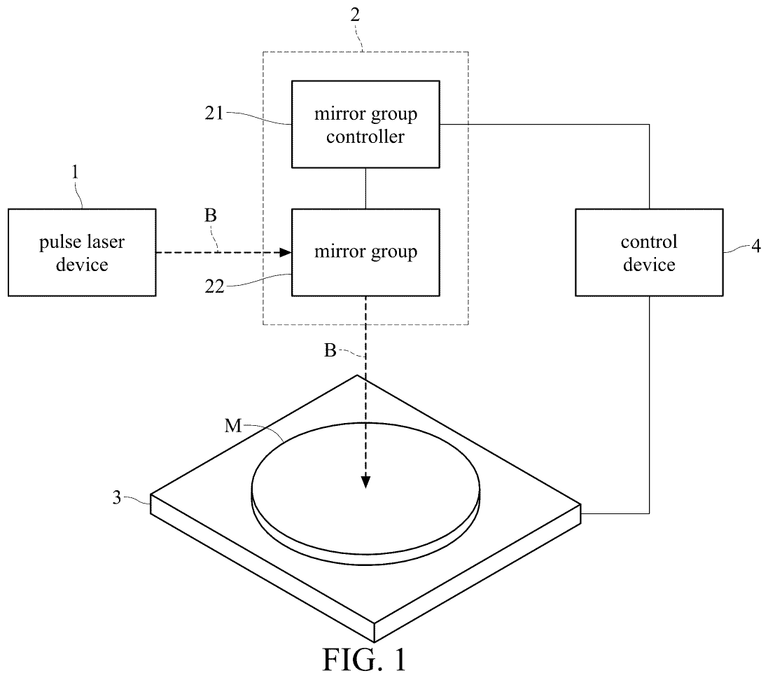

Please refer to FIG. 1 which is a schematic diagram of a continuous laser processing system according to an embodiment of the present disclosure. As shown in FIG. 1, a continuous laser processing system includes a pulse laser device 1, a scanning device 2, a processing platform 3 and a control device 4. The pulse laser device 1 is configured to output a laser beam B. The scanning device 2 includes a mirror group controller 21 and a mirror group 22 controlled to guide the laser beam B to the transparent material M on the processing platform 3, wherein the mirror group 22 is disposed at an output path of the laser beam B. The processing platform 3 is configured to carry the transparent material M and controlled to move. The control device 4 is electrically connected to the scanning device 2 and the processing platform 3, and is configured to control the scanning device 2 to form a processing trajectory at the transparent material M at a scanning speed, and to control the processing platform 3 to move at a translation speed, wherein the scanning speed is at least 20 times the translation speed.

The continuous laser processing system of the present disclosure is configured to internally modify the transparent material M. The wavelength of the laser beam B output by the pulse laser device 1 may be within a range of 300 to 1700 nanometers, and the pulse width may be at the levels of nanosecond (ns), picosecond (ps) or femtosecond (fs). The transparent material M may be a semiconductor material such as silicon carbide (SiC), or other transparent materials such as silicon dioxide (SiO2). In practice, appropriate laser parameters may be selected for different materials to perform internal modification of the materials. For example, for silicon carbide materials, a laser beam with a wavelength in the near-infrared range (such as a wavelength of 1064 nanometers) may be used; for silicon dioxide materials, a laser beam with a wavelength in the green or ultraviolet range (such as a wavelength of 532 or 343 nm) may be used. In addition, the pulse laser device 1 may be independently controlled by an additional control device or controlled by the control device 4, which is not limited in the present disclosure.

In the present embodiment, the mirror group controller 21 may be configured to adjust the guiding angle, direction and position of the mirror group 22 so that a beam spot of the laser beam B generates a scanning trajectory at the transparent material M, wherein the mirror group 22 may include one or more reflection mirrors (reflectors) and lenses. The processing platform 3 may carry the transparent material M and produce controlled translation. When the scanning device 2 and the processing platform 3 work in coordination, a specific processing trajectory may be generated inside the transparent material M. The control device 4 may include a computer and two time controllers. The computer is connected to the two time controllers, and uses control software to control the scanning speed of the scanning device 2 and the translation speed of the processing platform 3 through the two time controllers. The control device 4 may determine the magnification relationship between the scanning speed of the scanning device 2 and the translation speed of the processing platform 3 based on an input value or a preset value. For example, the control device 4 may control the scanning speed to be at least 20 times the translation speed, or preferably more than 100 times.

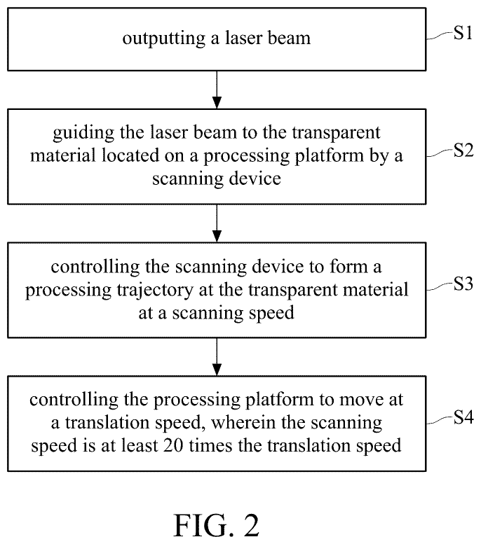

Please refer to FIG. 2 which is a flow chart of a continuous laser processing method according to an embodiment of the present disclosure. As shown in FIG. 2, a continuous laser processing method includes step S1: outputting a laser beam; step S2: guiding the laser beam to the transparent material located on a processing platform by a scanning device; step S3: controlling the scanning device to form a processing trajectory at the transparent material at a scanning speed; and step S4: controlling the processing platform to move at a translation speed, wherein the scanning speed is at least 20 times the translation speed. Please refer to FIG. 2 along with FIG. 1. In step S1, a laser beam may be output by the pulse laser device 1. In step S2, the laser beam may be reflected to the transparent material M located on the processing platform 3 by the mirror group 22 of the scanning device 2. In step S3, the scanning device 2 may be controlled by the control device 4 to form a processing trajectory at the transparent material M at a scanning speed. In step S4, the processing platform 3 may be controlled by the control device 4 to move at a translation speed such that the scanning speed is at least 20 times the translation speed.

Furthermore, in steps S3 and S4, the control device 4 may determine the scanning speed of the scanning device 2 and the translation speed of the processing platform 3 according to the input value and the preset value. For example, the scanning speed may be the scanning angular velocity of the mirror group 22 multiplied by a distance between the mirror group 22 and the transparent material M. Therefore, the control software of the control device 4 may be input or pre-stored with the distance between the mirror group 22 and the transparent material M, and after calculating the corresponding scanning angular velocity according to the input scanning speed, a control command associated with the scanning angular velocity is sent to the mirror group controller 21 to control the scanning angular velocity of the mirror group 22 to achieve a specific scanning speed of the laser beam B at the transparent material M. In one implementation, the translation speed of the processing platform may be set to a fixed value (such as 50 millimeters per second), and the control device 4 may control the scanning speed of the scanning device 2 and the translation speed to be a desired magnification (such as 20 times to 120 times). That is, the scanning speed is controlled to be from 1000 millimeters (mm) per second to 6000 mm per second.

The mirror group controller 21 and the mirror group 22 of the scanning device 2 described above may be implemented in different ways in different embodiments. For example, the mirror group 22 may have a first rotation axis, and the control device 4 may control a first scanning angular velocity of the mirror group 22 corresponding to the first rotation axis through the mirror group controller 21 to periodically generate one-dimensional patterns. Further, the mirror group 22 may also have a second rotation axis different from the first rotation axis, and the control device 4 may control a first scanning angular velocity of the mirror group 22 corresponding to the first rotation axis and a second scanning angular velocity of the mirror group 22 corresponding to the second rotation axis through the mirror group controller 21 to periodically generate two-dimensional patterns.

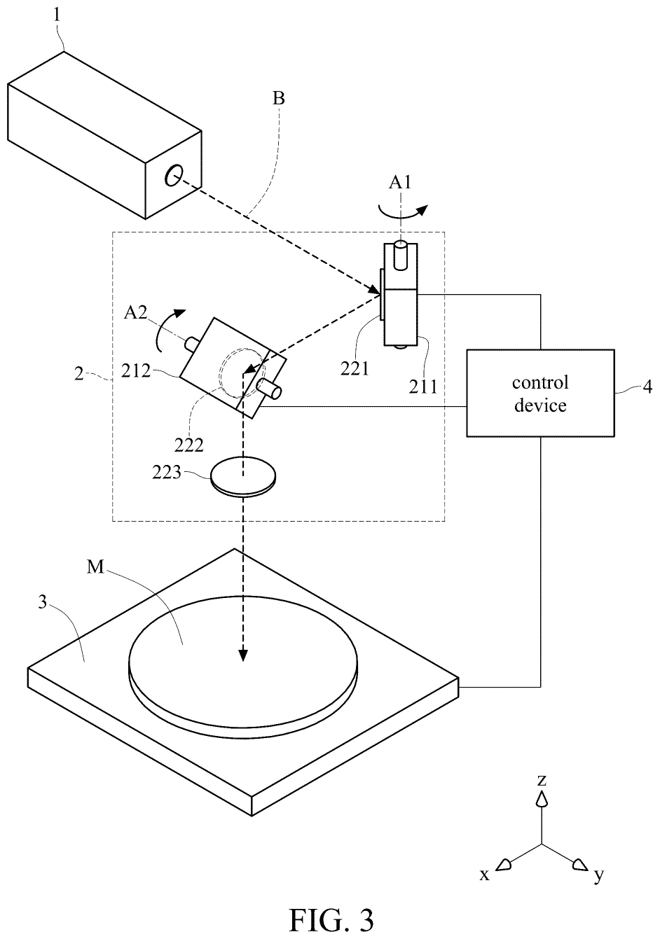

Please refer to FIG. 3 along with FIG. 1, FIG. 3 is a schematic diagram of a continuous laser processing system according to another embodiment of the present disclosure. As shown in FIG. 3, the continuous laser processing system of the present embodiment also includes a pulse laser device 1, a scanning device 2, a processing platform 3 and a control device 4 as shown in FIG. 1, wherein the scanning device 2 specifically includes a first mirror group controller 211, a first reflecting mirror 221, a second mirror group controller 212, a second reflecting mirror 222 and a focusing objective lens 223. The continuous laser processing system and processing method of the present embodiment will be exemplarily described below with reference to the directions X, Y, and Z shown in FIG. 3. In the present embodiment, the laser beam B output by the pulse laser device 1 propagates along the positive direction Y, and the first reflecting mirror 221 (and the first mirror group controller 211) and the second reflecting mirror 222 (and the second mirror group controller 212) are disposed at an output path of the laser beam B and are used to reflect the laser beam B and guide the processing trajectory of the laser beam B at the transparent material M.

The first reflection mirror 221 has a first rotation axis A1, and the control device 4 may control the rotation angle of the first reflection mirror 221 corresponding to the first rotation axis A1 through the first mirror group controller 211, wherein the direction of the first rotation axis A1 is the same as direction Z. The second reflection mirror 222 has a second rotation axis A2, and the control device 4 may control the rotation angle of the second reflection mirror 222 corresponding to the second rotation axis A2 through the second mirror group controller 212, wherein the direction of the second rotation axis A2 is the same as direction Y. When the control device 4 controls the rotation angles of the two mirrors respectively, the laser beam B may generate processing trajectories in different directions at the transparent material M. For example, as shown in FIG. 3, when the second reflection mirror 222 is controlled to rotate along the second rotation axis A2, the laser beam B may generate a processing trajectory along the direction X at the transparent material M; when the first reflection mirror 221 is controlled to rotate along the first rotation axis A1, the laser beam B may generate a processing trajectory along the direction Y at the transparent material M.

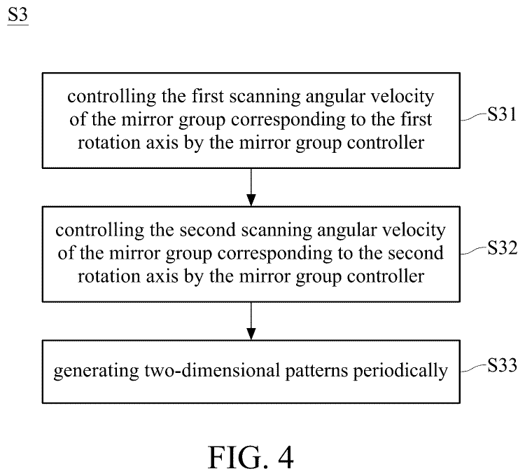

Please refer to FIG. 4 along with FIGS. 2 and 3. FIG. 4 is a flow chart of controlling the scanning device to form a processing trajectory on a transparent material at a scanning speed of a continuous laser processing method according to an embodiment of the of the present disclosure. That is, the “controlling the scanning device to form a processing trajectory at the transparent material at a scanning speed” of step S3 shown in FIG. 2 may include step S31: controlling the first scanning angular velocity of the mirror group corresponding to the first rotation axis by the mirror group controller; step S32: controlling the second scanning angular velocity of the mirror group corresponding to the second rotation axis by the mirror group controller; and step S33: generating two-dimensional patterns periodically. It should be noted that although FIG. 3 shows a specific solution for two mirror groups corresponding to different rotation axes to controllably adjust the processing trajectory of the laser beam, in other implementations, one or more reflection mirrors may be used to adjust the processing trajectory of the laser beam, and each reflection mirror may correspond to one or more rotation axes. For example, one of the one or more reflectors in the mirror group 22 may have two different rotation axes, and the control device 4 may respectively control the scanning angular velocities of the reflector corresponding to the two rotation axes through the mirror group controller, thereby generating a processing trajectory with a two-dimensional pattern. Therefore, the present disclosure does not limit the number of reflectors in the mirror group 22.

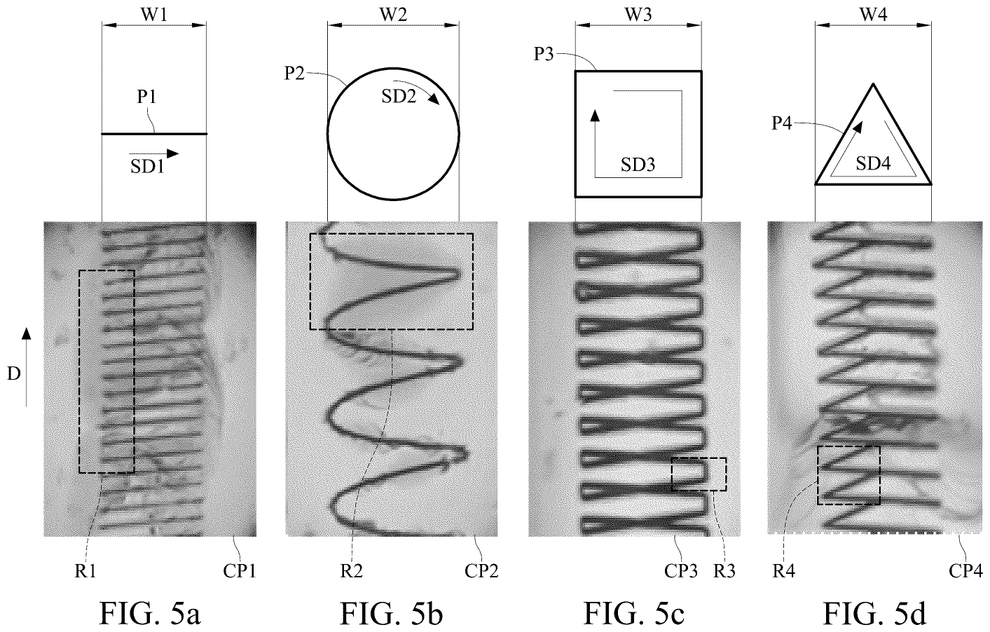

Please refer to FIGS. 5a to 5d along with FIG. 1. FIGS. 5a to 5d are schematic diagrams of forming a processing trajectory of the continuous laser processing method according to an embodiment of the present disclosure. As shown in FIG. 5a, the control device 4 may control the scanning device 2 to perform scanning along a scanning direction SD1 unidirectionally to generate a one-dimensional pattern P1, and at the same time, the control device 4 controls the processing platform 3 to translate along the translation direction D. Accordingly, when the scanning device 2 continuously scans the transparent material M with the laser beam B along the scanning direction SD1, the processing platform 3 moves along the translation direction D perpendicular to the scanning direction SD1, so that a processing trajectory with a continuous pattern CP1 is formed at the transparent material M. During this laser scanning and platform translation process, by controlling the two speeds mentioned above to be above a specific magnification, a dense periodic processing trajectory (laser modification area) may be formed at the transparent material extending along the translation direction D, so that when the periodic processing trajectory is dense enough, the laser modification area may be regarded as a continuous modification area. In other words, the higher the magnification of the two speeds is, the denser the generated periodic processing trajectory may be, thereby achieving the effect of line-segment laser processing (or continuous laser modification). In addition, the above-mentioned scanning speed may refer to an average scanning speed of the laser beam during periodic scanning.

It should be noted that in the present embodiment, the rotation angle of the mirror group 22 controlled by the control device 4 through the mirror group controller 2 is within an angular range. The angular range corresponds to a processing width W1 of the processing trajectory formed by the scanning device 2 guiding the laser beam B to the transparent material M, such that the processing width W1 is greater than 100 micrometers (for example, 500 micrometers), and the direction of the processing width W1 is perpendicular to the translation direction D of the translation speed. In addition, the pulse laser device 1 of the present embodiment may be synchronously controlled by the control device 4 or other time controllers, so that the pulse laser device 1 may be controlled to match the scanning process of the scanning device 2. For example, the switching control of the pulse laser device 1 is performed at a specific frequency to produce the effect of spaced line segments as shown in FIG. 5a.

As shown in FIG. 5b, the control device 4 may control the scanning device 2 to scan along a scanning direction SD2 circularly to generate a two-dimensional pattern P2, and at the same time, the control device 4 controls the processing platform 3 to translate along the translation direction D. Accordingly, when the scanning device 2 continuously scans the transparent material M with the laser beam B along the scanning direction SD2, the processing platform 3 moves along the translation direction D perpendicular to a horizontal component of the scanning direction SD2, so that a processing trajectory with a continuous pattern CP2 is formed at the transparent material M. In the present embodiment, the control device 4 may control the first scanning angular velocity (horizontal component) and the second scanning angular velocity (vertical component) of the mirror group 22 to have a phase difference therebetween through the mirror group controller 21 to periodically generate circular patterns. For example, the control device 4 may control the first scanning angular velocity to lead the second scanning angular velocity by a phase difference of 90 degrees. The control device 4 also controls the horizontal component of the rotation angle of the mirror group 22 to be within an angular range through the mirror group controller 21. The angular range corresponds to a processing width W2 of the processing trajectory formed by the scanning device 2 guiding the laser beam B to the transparent material M, wherein the direction of the processing width W2 is perpendicular to the translation direction D of the translation speed.

As shown in FIGS. 5c and 5d, the control device 4 may control the scanning device 2 to scan along a scanning direction SD3 in a square shape (or a scanning direction SD4 in a triangular shape) to generate a two-dimensional pattern P3 (or P4), and at the same time, the control device 4 controls the processing platform 3 to translate along the translation direction D. Accordingly, when the scanning device 2 continuously scans the transparent material M with the laser beam B along the scanning direction SD3 (or SD4), the processing platform 3 moves along the translation direction D perpendicular to a horizontal component of the scanning direction SD3 (or SD4), so that a processing trajectory with a continuous pattern CP3 (or CP4) is formed at the transparent material M. In the present embodiment, the control device 4 may control the first scanning angular velocity (horizontal component) and the second scanning angular velocity (vertical component) of the mirror group 22 to have a phase difference therebetween through the mirror group controller 21 to periodically generate square patterns (or triangular patterns). The control device 4 also controls the horizontal component of the rotation angle of the mirror group 22 to be within an angular range through the mirror group controller 21. The angular range corresponds to a processing width W3 (or W4) of the processing trajectory formed by the scanning device 2 guiding the laser beam B to the transparent material M, wherein the direction of the processing width W3 (or W4) is perpendicular to the translation direction D of the translation speed.

Through the above method, compared with the prior technology of linear modification processing through a single beam spot, in which the line width is only 5 to 10 microns, the continuous laser processing system and processing method of the present disclosure may effectively increase the processing width of a single processing trajectory to hundreds of micrometers, thereby expanding the line width of multiple laser processing channels, so that under the same processing area, the overall processing length is reduced and the processing efficiency is improved. In addition, please refer to FIGS. 5a to 5d. By using the control device to control the direction of the scanning speed to switch back and forth between a first direction and a second direction opposite to the first direction, with each of the first direction and the second direction crossing the translation direction D of the translation speed, multiple turning points may be generated on the processing trajectory of the material. That is, when the control device controls the scanning speed to switch back and forth in the direction perpendicular to the translation direction D, multiple turning points may be generated on the processing trajectory of the material, thereby generating multiple stress concentration points in the material. As shown in FIGS. 5a to 5d, there are stress concentration areas R1, R2, R3 and R4 at the turning points of the processing trajectory. By generating more fine transverse cracks in these stress concentration areas R1, R2, R3 and R4, the force required for subsequent slitting may be reduced and the surface roughness of the material cross-section surface may be reduced.

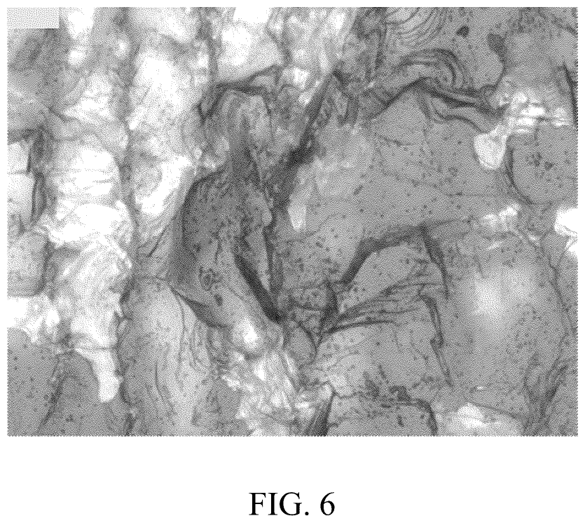

Please refer to FIG. 6 which is a photograph of a cross-section surface of the processed material formed by a continuous laser processing method according to an embodiment of the present disclosure. Please also refer to data recited in Table 1:

TABLE 1

| | Roughness |
|---|---|
| Sa, Arithmetic mean height(μm) | 5.0417 |
| Sz, Maximum height(μm) | 35.3732 |
| Str, Texture aspect ratio | 0.489 |
| Spc, Arithmetic mean peak curvature (1/mm) | 2179.2306 |
| Sdr, Developed interfacial area ratio | 0.2575 |

As shown in FIG. 6 and Table 1, the arithmetic mean roughness of the cross-section surface of the processed material produced by the continuous laser processing system and processing method of the present disclosure is reduced to less than 5 microns (Ra<5 μm). That is, through the above-mentioned continuous pattern laser scanning processing solution, multiple stress concentration points may be generated at the turning points of the processing trajectory in the material, thereby reducing the force required for subsequent dicing and reducing the surface roughness of the material cross-section surface. In comparison, if the traditional single light spot method is used for linear modification processing, the arithmetic mean roughness of the material cross-section surface is usually between 5 and 10 microns (Ra=5˜10 μm). Therefore, the present disclosure has significantly improved the quality of wafer dicing. It should be noted that as the magnification between scanning speed and translation speed increases, more turning points may be generated, that is, more stress concentration points are generated, which is also conducive to improving the quality of wafer dicing. In addition, the various data shown in Table 1 are merely an example of the effects on cross-section surface that may be achieved in the present disclosure, wherein the parameters and terminology may be understood by those with ordinary skill in the art and will not be described in detail here.

In view of the above description, the continuous laser processing system and processing method of the present disclosure may use software or program to simultaneously control the scanning speed of the scanning device and the translation speed of the processing platform through the control device, so that the speed ratio between the two is maintained above a specific magnification, and during the translation process of the processing platform, a continuous processing trajectory may be scanned for the transparent semiconductor material on the processing platform to perform continuous line-segment modification processing. The above-mentioned line-segment modification processing technology may increase the processing line width by at least twice as much as the traditional linear modification processing through a single beam spot, and may effectively improve the efficiency of the overall laser modification process. In addition, the design of the laser scanning pattern in the present disclosure may generate multiple stress concentration points in the modification areas inside the material, and reduce the surface roughness of the material cross section, thereby improving the internal modification quality of the semiconductor material.

What is claimed is:

1. A continuous laser processing system for internal modification of a transparent material, comprising:
a pulse laser device configured to output a laser beam;
a scanning device comprising a mirror group controller and a mirror group and controlled to guide the laser beam to the transparent material, wherein the mirror group is disposed at an output path of the laser beam;
a processing platform configured to carry the transparent material and controlled to move; and
a control device electrically connected to the scanning device and the processing platform, and configured to control the scanning device to form a processing trajectory at the transparent material at a scanning speed, and to control the processing platform to move at a translation speed, wherein the scanning speed is at least 20 times the translation speed.

2. The continuous laser processing system of claim 1, wherein the scanning speed is at least 100 times the translation speed.

3. The continuous laser processing system of claim 1, wherein the mirror group has a first rotation axis, and the control device is configured to control a first scanning angular velocity of the mirror group corresponding to the first rotation axis through the mirror group controller to periodically generate one-dimensional patterns.

4. The continuous laser processing system of claim 3, wherein the mirror group further has a second rotation axis different from the first rotation axis, and the control device is configured to control the first scanning angular velocity of the mirror group corresponding to the first rotation axis and a second scanning angular velocity of the mirror group corresponding to the second rotation axis through the mirror group controller to periodically generate two-dimensional patterns.

5. The continuous laser processing system of claim 4, wherein the control device is further configured to control the first scanning angular velocity and the second scanning angular velocity of the mirror group to have a phase difference therebetween through the mirror group controller to periodically generate the two-dimensional patterns.

6. The continuous laser processing system of claim 1, wherein the scanning speed is a speed greater than 1000 millimeters per second.

7. The continuous laser processing system of claim 1, wherein the mirror group has a rotation axis and a rotation angle corresponding to the rotation axis, and the control device is configured to control the rotation angle of the mirror group to be within an angular range through the mirror group controller, wherein the angular range corresponds to a processing width of the processing trajectory formed by the scanning device guiding the laser beam to the transparent material, the processing width is greater than 100 micrometers, and a direction of the processing width is perpendicular to a direction of the translation speed.

8. The continuous laser processing system of claim 1, wherein the control device is configured to control a direction of the scanning speed to switch back and forth between a first direction and a second direction opposite to the first direction, with each of the first direction and the second direction crossing a direction of the translation speed.

9. The continuous laser processing system of claim 1, wherein the transparent material is a silicon carbide material and a wavelength of the laser beam belongs to near-infrared.

10. The continuous laser processing system of claim 1, wherein the transparent material is a silicon dioxide material and a wavelength of the laser beam belongs to ultraviolet or green light.

11. A continuous laser processing system for internal modification of a transparent material, comprising:
outputting a laser beam by a pulse laser device;
guiding the laser beam to the transparent material located on a processing platform by a scanning device;
controlling the scanning device to form a processing trajectory at the transparent material at a scanning speed by a control device; and
controlling the processing platform to move at a translation speed by the control device, wherein the scanning speed is at least 20 times the translation speed.

12. The continuous laser processing method of claim 11, wherein the scanning speed is 20 to 120 times the translation speed.

13. The continuous laser processing method of claim 11, wherein the mirror group has a first rotation axis, and controlling the scanning device to form the processing trajectory at the transparent material at the scanning speed by the control device comprises:
controlling a first scanning angular velocity of the mirror group corresponding to the first rotation axis through the mirror group controller to periodically generate one-dimensional patterns.

14. The continuous laser processing method of claim 13, wherein the mirror group further has a second rotation axis different from the first rotation axis, and controlling the scanning device to form the processing trajectory at the transparent material at the scanning speed by the control device further comprises:
controlling the first scanning angular velocity of the mirror group corresponding to the first rotation axis and a second scanning angular velocity of the mirror group corresponding to the second rotation axis through the mirror group controller to periodically generate two-dimensional patterns.

15. The continuous laser processing method of claim 14, wherein controlling the first scanning angular velocity of the mirror group corresponding to the first rotation axis and the second scanning angular velocity of the mirror group corresponding to the second rotation axis through the mirror group controller to periodically generate two-dimensional patterns comprises:
controlling the first scanning angular velocity and the second scanning angular velocity of the mirror group to have a phase difference therebetween through the mirror group controller to periodically generate the two-dimensional patterns.

16. The continuous laser processing method of claim 11, wherein the scanning speed is a speed greater than 1000 millimeters per second.

17. The continuous laser processing method of claim 11, wherein the mirror group has a rotation axis and a rotation angle corresponding to the rotation axis, and controlling the scanning device to form the processing trajectory at the transparent material at the scanning speed by the control device comprises:
controlling the rotation angle of the mirror group to be within an angular range through the mirror group controller, wherein the angular range corresponds to a processing width of the processing trajectory formed by the scanning device guiding the laser beam to the transparent material, the processing width is greater than 100 micrometers, and a direction of the processing width is perpendicular to a direction of the translation speed.

18. The continuous laser processing method of claim 11, wherein controlling the scanning device to form the processing trajectory at the transparent material at the scanning speed by the control device comprises:
controlling a direction of the scanning speed to switch back and forth between a first direction and a second direction opposite to the first direction, with each of the first direction and the second direction crossing a direction of the translation speed.

19. The continuous laser processing method of claim 11, wherein the transparent material is a silicon carbide material and a wavelength of the laser beam belongs to near-infrared.

20. The continuous laser processing method of claim 11, wherein the transparent material is a silicon dioxide material and a wavelength of the laser beam belongs to ultraviolet or green light.
